(19) United States
(12) Patent Application Publication
(10) Pub. No.: US 2008/0072055 A1
(43) Pub. Date: Mar. 20, 2008

(54) Digital signature scheme based on the division algorithm and the discrete logarithm problem

(76) Inventors: Nikolajs Volkovs, Toronto (CA); Vijaya Kumar Murty, Toronto (CA)

Correspondence Address: KRAMER & AMADO, P.C., 1725 DUKE STREET, SUITE 240, ALEXANDRIA, VA, 22314, US

(21) Appl. No.: 11/797,978

(22) Filed: May 9, 2007

(30) Foreign Application Priority Data
May 9, 2006 (CA) CA 2,545,975

(51) Int. Cl. H04L 9/28; H04L 9/30

(52) U.S. Cl. 713/180; 380/30

(57) ABSTRACT

A method of creating a secure digital signature, including one or more of the following: a sender, based on a private key K and message x, calculates a unique pair of integers q and r such that int(K)=int(h)q+r, then chooses a cyclic group G with generator g, for which the discrete logarithm problem is a hard problem and computes the public key g^{int(K)}, and calculates a pair (g^{q}, g^{r}), which is the digital signature of x, a receiver, who knows a public key g^{int(K)}, obtains a message y and a digital signature in a form of pair (g^{q}, g^{r}) and calculates the following two expressions g^{int(K)}(g^{r})⁻¹ and (g^{q})^{int(y)}, the algorithm generates “TRUE”, if the two expressions match, and “FALSE”, if they do not.

### 1. INTRODUCTION

Digital Signature is a method of authenticating digital information. The output of a digital signature algorithm is a binary string (or a pair of strings) that provides authenticity, integrity and non-repudiation of the transmitted message.

Digital signature algorithms are based on public key cryptography (A. J. Menezes, P. C. van Oorschot, S. A. Vanstone, Handbook of Applied Cryptography. CRC Press, 1997) and consist of two parts—a signing algorithm and a verification algorithm.

Digital signature algorithms, such as Lamport Signatures, Matyas-Meyer Signatures, RSA Signatures, ElGamal Signatures and others, are well-known and widely-used in practice (Josef Pieprzyk, Thomas Hardjono, Jennifer Sebbery, Fundamentals of Computer Security, Springer-Verlag, 2003).

The National Institute of Standards and Technology (NIST) has published the Federal Information Processing Standard FIPS PUB 186, also known as Digital Signature Standard (DSS). The DSS uses SHA as hashing algorithm and the Digital Signature Algorithm (DSA). The DSA is based on the difficulty of computing the discrete logarithm problem and is based on schemes presented by ELGamal and Shnorr (Josef Pieprzyk, Thomas Hardjono, Jennifer Sebbery, Fundamentals of Computer Security, Springer-Verlag, 2003).

We present a digital signature algorithm, which is also based on difficulty of computing the discrete logarithm problem (I. F. Blake, G. Seroussi, N. Smart, Elliptic Curves in Cryptography, LMS Lecture Notes 265, Cambridge University Press, Cambridge, 2000), but is different from ELGamal and the DSA scheme.

The main advantages of the presented digital signature algorithm is the fact that it can be naturally and easily combined with the new scheme of Message Authentication Coding with transformations proposed by the authors (Canadian Patent Application No. CA 2,552,085; U.S. patent application Ser. No. 11/457,669). Thus, in this framework, one can easily implement both a Message Authentication Coding system (with transformations that allow generating a MAC value with sufficiently improved characteristics of security) and the proposed digital signatures scheme without any additional programming tools.

### 2. A DIGITAL SIGNATURE SCHEME

We will first consider some background information (Josef Pieprzyk, Thomas Hardjono, Jennifer Sebbery, Fundamentals of Computer Security, Springer-Verlag, 2003). A digital signature scheme is a collection of two algorithms: the signing algorithm and the verification algorithm.

The signing algorithm
SG:Γ·Δ→S
assigns a signature s to a pair d, m, where dεΓ is a secret key and mεΔ is a message, that is, SG(d, m)=s.

The verification algorithm
VER:Γ′·Δ·S→{t,f}
using the public key eεΓ′ of the signer, the message mΓΔ and checks whether the pair (e, m) matches the signature s. If there is a match, the algorithm returns t—TRUE. Otherwise, it generates f—FALSE.

2.1. ELGamal Digital Signature Scheme. As an example of a digital signature, consider the ElGamal algorithm variants of which are in actual use (Josef Pieprzyk, Thomas Hardjono, Jennifer Sebbery, Fundamentals of Computer Security, Springer-Verlag, 2003).

A sender (Sally) considers a finite field GF(p), in which the discrete logarithm problem is difficult. Then, she selects a primitive element gεGF(p)^{k} and a random integer k in the interval [1, p−1]. This allows one to compute the public key g^{k} mod p.

Then, Sally sends g^{k}, g and p to the public registry.

The Signing Algorithm:

For a message mεGF(p), Sally selects a random integer rε[1, p−1], such that gcd(r, p−1)=1, and calculates
x≡g^{r} mod p.

Then, she solves the following congruence
m≡k·x+r·y mod p
for y.

The signature is
s=SGₖ(m)=(x,y).

Sally keeps secret k and r.

The Verification Algorithm:

A receiver (Bob) receives the message \tilde{m} and \tilde{s}=(\tilde{x}, \tilde{y}). He then checks whether
VER(\tilde{m},\tilde{s})=(g^{\tilde{m}}≡(g^{k})^{\tilde{x}}·\tilde{x}^{\tilde{y}} mod p).

### 3. THE PROPOSED DIGITAL SIGNATURE SCHEME

Now, we want to present a digital signature scheme that naturally arises and can be effectively combined with a MAC (or Hash) function with transformation, considered earlier by the authors (Canadian Patent Application No. CA 2,552,085; U.S. patent application Ser. No. 11/457,669).

We remark that when we consider a message x in a digital signature, we deal with the hash or MAC value of the original message.

The Signing Procedure. We begin with a cyclic group G of prime order of size 2^{α}. We also fix a generator g of G. A sender chooses a private key K, say of k bits. Then, the sender computes the public key g^{int(K)}. Given a message M, it is hashed or MAC-ed to m. We assume that m has h bits where
h<k (1)
and
max(h,k−h)<α (2)

Then a random sessional number z≠0 is generated, which is kept secret. The number of bits of z is at most h. Then, using the division algorithm, the sender calculates a unique pair of integers q and r such that
int(K)=(int(m)+z)q+r. (3)

Here, int(K) and int(m) are integers, the binary presentation of which are the sequences of bits K and m, correspondingly.

The digital signature is the pair (x, y) where
x=(g^{-zq-r})
and
y=g^{q}.

If, by coincidence, zq+r is 0 it is necessary to choose another z and recalculate the pair q and r in accordance with (3).

The Verification Procedure. A receiver obtains a message M′ and a digital signature in the form of a pair (x, y). Besides, a receiver knows the public key g^{int(K)}, as well as the group G and the generator g.

The message M′ is hashed (or MAC-ed with the corresponding key) to m′, and the following two expressions are calculated
xg^{int(K)},y^{int(m′)}. (4)

If they are equal, then the signature is valid. If they are not equal, the signature is not valid and the message may be rejected.

The next theorem shows that the proposed scheme and the evaluation procedure are correct.

Theorem 1. If M and M′ are two messages for which the hash m and m′ are distinct, then the two quantities in (4) are unequal.

Proof. If the two quantities are equal then
qint(m)≡qint(m′)(mod |G|).

Note that the converse also holds. From (3), we have
q<2^{k-h}
and by (1) and (2), this is strictly smaller than |G|. As |G| is prime, (|G|, q)=1, and so the above congruence implies that
int(m)≡int(m)(mod |G|). (5)

Again from (1) and (2), we have
int(m),int(m′)<2^{h}<2^{α}<|G|.

Thus, the congruence (5) implies that m and m′ are equal, contradicting our assumption.

### 4. IMPLEMENTATION

As one example, the method of the present invention can be readily implemented in a Dynamically Linked Library (or DLL), which is linked to a computer program that utilizes an algorithm that embodies the digital signature algorithm described above, for example, an encryption, decryption or authentication utility that is operable to apply said algorithm.

The computer program of the present invention is, therefore, best understood as a computer program that includes computer instructions operable to implement an operation consisting of the calculation of the digital signature string (pair of strings) as described above.

Another aspect of the present invention is a computer system that is linked to a computer program that is operable to implement, on the computer system, the digital signature algorithm in accordance with the present invention, together with the System of Transformation of a MAC-value (Canadian Patent Application No. CA 2,552,085; U.S. patent application Ser. No. 11/457,669). This invention will be of use in any environment where MAC functions are used for data integrity together with digital signatures.

As another example, the method of the present invention can be readily implemented in a specially constructed hardware device. As discussed above, an integrated circuit can be created to perform the calculations necessary to create a digital signatures string. Other computer hardware can perform the same function. Alternatively, computer software can be created to program existing computer hardware to create digital signature values.

1. A method of creating a secure digital signature comprising the following steps:
(a) a sender, based on a private key K and message x, calculates a unique pair of integers q and r such that int(K)=int(h)q+r, then chooses a cyclic group G with generator g, for which the discrete logarithm problem is a hard problem and computes the public key g^{int(K)}, and calculates a pair (g^{q}, g^{r}), which is the digital signature of x,
(b) a receiver, who knows a public key g^{int(K)}, obtains a message y and a digital signature in a form of pair (g^{q}, g^{r}) and calculates the following two expressions g^{int(K)}(g^{r})⁻¹ and (g^{q})^{int(Y)},
(c) the algorithm generates “TRUE”, if the two expressions match, and “FALSE”, if they do not.

2. A method of creating a secure digital signature as set out in claim 1, characterized in that private key K is about two times bigger (within a range of plus or minus 25%) (as a string) than message x.

3. A method of creating a secure digital signature as set out in claim 1, wherein the method is implemented in a Dynamically Linked Library (DLL), which is linked to a computer program that utilizes an algorithm that embodies the digital signature algorithm.

4. A method of creating a secure digital signature as set out in claim 3, characterized in that the computer program includes computer instructions operable to implement an operation consisting of the calculation of the digital signature.

5. A method of creating a secure digital signature as set out in any one of claims 3 or 4, characterized in that the computer program is an encryption, decryption or authentication utility.

6. A computer system comprising software that is operable to implement on a computer system the digital signature algorithm of any one of claims 1 to 5 together with a system of transformation of a MAC-value.

7. An integrated circuit adapted to perform the calculations necessary to create the digital signature pair of any one of claims 1 to 5.

8. A computer system comprising software to program existing computer hardware to calculate the digital signature of any of claims 1 to 7.
